(19) United States
(12) Patent Application Publication
(10) Pub. No.: US 2007/0200646 A1
(43) Pub. Date: Aug. 30, 2007

(54) Method for coupling out of a magnetic device

(75) Inventors: Jonathan Gorrell, Gainesville, FL (US); Mark Davidson, Florahome, FL (US); Jean Tokarz, Hawthorne, FL (US); Michael E. Maines, Gainesville, FL (US); Henry Davis, Ash Fork, AZ (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Island Microsystems, Inc., St. Thomas, VI (US)

(21) Appl. No.: 11/418,086

(22) Filed: May 5, 2006

Related U.S. Application Data
(60) Provisional application No. 60/777,120, filed on Feb. 28, 2006.

(51) Int. Cl. H01P 5/18

(52) U.S. Cl. 333/113

(57) ABSTRACT

A device for determining the state of a magnetic element includes an emitter constructed and adapted to emit a charged particle beam; a bi-state magnetic cell disposed on a path of the particle beam, whereby the particle beam is deflected along a first deflection path when the cell is in a first magnetic state, and the particle beam is deflected along a second deflection path, distinct from the first deflection path, when the cell is in a second magnetic state. At least one ultra-small resonant structure positioned on the deflection paths.

### CROSS-REFERENCE To RELATED APPLICATIONS

### Priority Application

This application is related to and claims priority from the following co-pending U.S. patent application, the entire contents of which is incorporated herein by reference: U.S. Provisional Patent Application No. 60/777,120, titled “Systems and Methods of Utilizing Resonant Structures,” filed Feb. 28, 2006 [Atty. Docket No. 2549-0087].

### Related Applications

The present invention is related to the following co-pending U.S. ptent applications which are all commonly owned with the present application, the entire contents of each of which are incorporated herein by reference:
1. U.S. application Ser. No. 11/302,471, entitled “Coupled Nano-Resonating Energy Emitting Structures,” filed Dec. 14, 2005,
2. U.S. application Ser. No. 11/349,963, entitled “Method And Structure For Coupling Two Microcircuits,” filed Feb. 9, 2006;
3. U.S. patent application Ser. No. 11/238,991, filed Sep. 30, 2005, entitled “Ultra-Small Resonating Charged Particle Beam Modulator”;
4. U.S. patent application Ser. No. 10/917,511, filed on Aug. 13, 2004, entitled “Patterning Thin Metal Film by Dry Reactive Ion Etching”;
5. U.S. application Ser. No. 11/203,407, filed on Aug. 15, 2005, entitled “Method Of Patterning Ultra-Small Structures”;
6. U.S. application Ser. No. 11/243,476, filed on Oct. 5, 2005, entitled “Structures And Methods For Coupling Energy From An Electromagnetic Wave”;
7. U.S. application Ser. No. 11/243,477, filed on Oct. 5, 2005, entitled “Electron beam induced resonance,”
8. U.S. application Ser. No. 11/325,448, entitled “Selectable Frequency Light Emitter from Single Metal Layer,” filed Jan. 5, 2006;
9. U.S. application Ser. No. 11/325,432, entitled, “Matrix Array Display,” filed Jan. 5, 2006,
10. U.S. application Ser. No. 11/410,905, entitled, “Coupling Light of Light Emitting Resonator to Waveguide,” and filed Apr. 26, 2006 [Atty. Docket 2549-0077];
11. U.S. application Ser. No. 11/411,120, entitled “Free Space Interchip Communication,” and filed Apr. 26, 2006 [Atty. Docket 2549-0079];
12. U.S. application Ser. No. 11/410,924, entitled, “Selectable Frequency EMR Emitter,” filed Apr. 26, 2006 [Atty. Docket 2549-0010];
13. U.S. application Ser. No. 11/______, entitled, “Multiplexed Optical Communication between Chips on A Multi-Chip Module,” filed on even date herewith [atty. docket 2549-0035];
14. U.S. patent application Ser. No. 11/400,280, titled “Resonant Detector for Optical Signals,” filed Apr. 10, 2006, [Atty. Docket No. 2549-0068].

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to magnetic devices, and, more particularly, to coupling data out of such devices using ultra-small resonant structures.

### INTRODUCTION

There has been a recent increase in the number of integrated devices that are based on magnetism, most notably, MRAM (Magnetoresistive Random Access Memory).

Unlike conventional RAM chip technologies, in an MRAM, data are not stored as electric charge or current flows, but by magnetic storage elements. The elements are formed from two ferromagnetic plates, each of which can hold a magnetic field, separated by a thin insulating layer. One of the two plates is a permanent magnet set to a particular polarity, the other's field will change to match that of an external field. A memory device is built from a grid of such cells. Various magnetic-based logic devices are also being developed.

It is desirable to couple data out of these magnetic devices.

### BRIEF DESCRIPTION OF THE DRAWINGS

The following description, given with respect to the attached drawings, may be better understood with reference to the non-limiting examples of the drawings, wherein:

FIGS. 1-4 show embodiments of magnetic cell coupling devices.

### THE PRESENTLY PREFERRED EXEMPLARY EMBODIMENTS

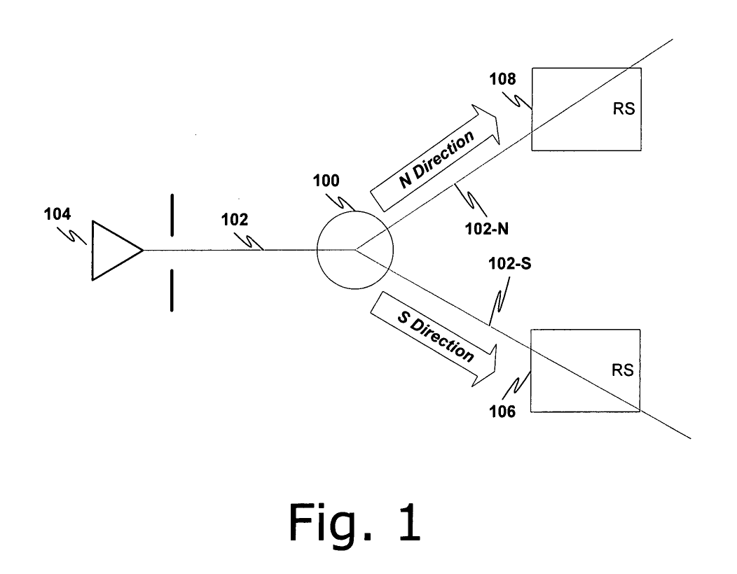

FIG. 1 shows a magnetic element/cell 100 which can be in one of two states, referred to here as “N” and “S”. Such an element/cell is also referred to herein as a bi-state device or cell or element. A beam 102 of charged particles (emitted by a emitter 104—a source of charged particles) is deflected by the magnetic element 100, depending upon and according to the state of the element. When the magnetic element 100 is in its so-called “N” state, the particle beam 102 will be deflected in the N direction, whereas when the magnetic element 100 is in its so-called “S” state, the particle beam 102 will be deflected in the S direction.

For the sake of this description, the drawings show the particle beam traveling in both the N and the S directions. Those of skill in the art will immediately understand, upon reading this description, that the particle beam will only travel in one of those directions at any one time. For the purposes of this description, the portion of the particle beam that is deflected in the N direction is also referred to as particle beam 102-N. Likewise, for the purposes of this description, the portion of the particle beam that is deflected in the S direction is also referred to as particle beam 102-S.

In one embodiment, ultra-small resonant structures 106, 108 are positioned along the S and N paths, respectively. The resonant structures 106, 108 may be any of the class of structures, as disclosed in the related co-pending patent applications.

Generally, the ultra-small resonant structures may emit light (such as infrared light, visible light or ultraviolet light or any other electromagnetic radiation (EMR) at a wide range of frequencies, and often at a frequency higher than that of microwave). The EMR is emitted when the resonant structure is exposed to a beam of charged particles ejected from or emitted by a source of charged particles. Preferably the particle beam passes adjacent the structures, the term “adjacent” including, without limitation, above the structures. The source may be controlled by applying a signal on a data input. The source can be any desired source of charged particles such as an ion gun, a field emission cathode, a thermionic filament, tungsten filament, a cathode, a vacuum triode, a planar vacuum triode, an electron-impact ionizer, a laser ionizer, a chemical ionizer, a thermal ionizer, an ion-impact ionizer, an electron source from a scanning electron microscope, etc. The particles may be positive ions, negative ions, electrons, and protons and the like.

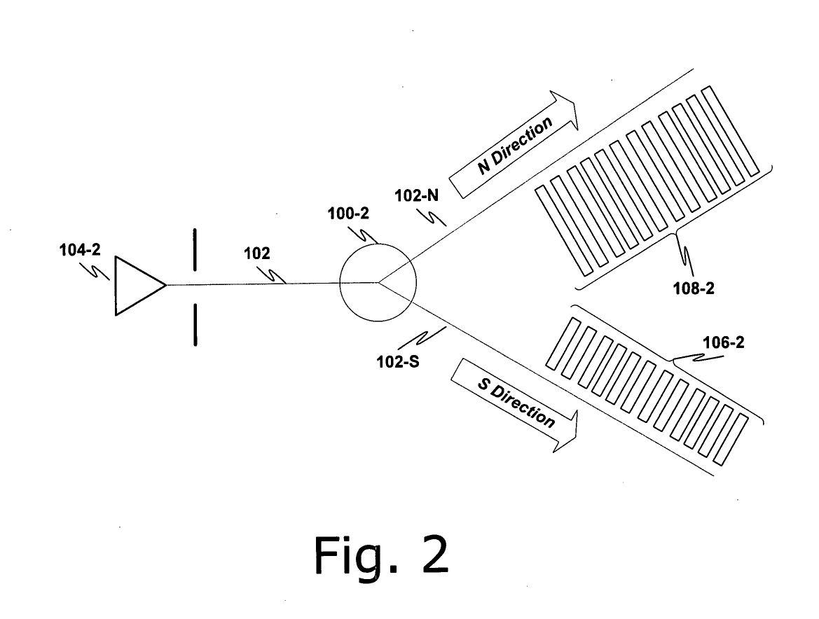

In particular, as shown in greater detail in FIG. 2 the resonant structures 106-2, 108-2 may be light-emitting resonant structures when induced by the beam of charged particles. Thus, when the magnetic cell 100-2 is in its “S” state, the particle beam will travel along the S path (particle beam 102-S) and the light-emitting resonant structure 106-2 will light up. When the magnetic cell 100-2 is in its “N” state, the particle beam 102-2 will travel along the N path (particle beam 102-N), and the light emitting resonant structure 108-2 will light up. The resonant structures 106-1, 108-1 are preferably selected to emit EMR (light) of different colors.

In some embodiments, the ultra-small structures 106, 108 may include detection structure (such as, e.g., the detectors described in U.S. patent application Ser. No. 11/400,280, [Atty. Docket 2549-0068], which was incorporated herein by reference). The detection mechanisms may be used to ascertain and provide the state of the magnetic cell 100 to other circuitry.

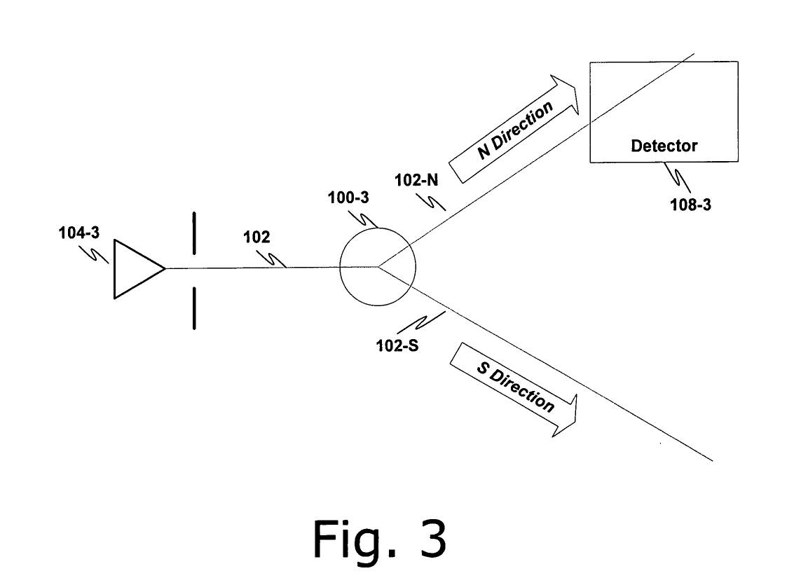

In another embodiment, as shown in FIG. 3, only one ultra-small resonant structure 108-3 need be provided. Here, the structure 108-3 comprises a detector such as, e.g., is described in U.S. patent application Ser. No. 11/400,280, [Atty. Docket 2549-0068], which was incorporated herein by reference. Such a detector 108-3 can be used to determine the binary state of the magnetic element 100-3 and to provide a signal indicative of the state to other circuitry (not shown). The detector 108-3 may be constructed and adapted to detect breaks or deflections of the beam 102-N.

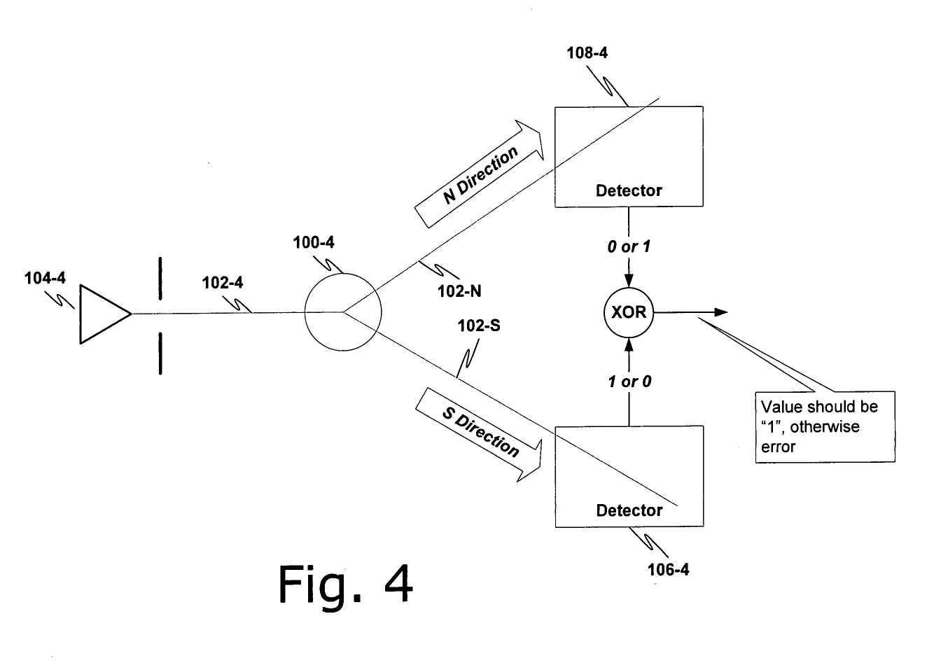

FIG. 4 shows an example in which both ultra-small structures 106-4 and 108-4 are detectors, e.g., as described in U.S. patent application Ser. No. 11/400,280, [Atty. Docket 2549-0068], which was incorporated herein by reference. The output of these detectors may be used to provide a signal indicative of the state of the magnetic element 100-4 to other circuitry (not shown). Since the magnetic element must be in one of two states, one of the two detectors 1064, 108-4 must be detecting the presence of a signal. Accordingly, an output of these two detectors may be combined to provide an error check. For example, assuming each detector outputs a binary “1” when it detects a signal and a binary “0” otherwise, then a logical exclusive-OR (“XOR”) of their outputs should always be a binary “1”.

The particles 102 in the charged particle beam can include ions (positive or negative), electrons, protons and the like. The beam may be produced by any source, including, e.g., without limitation an ion gun, a thermionic filament, a tungsten filament, a cathode, a planar vacuum triode, an electron-impact ionizer, a laser ionizer, a chemical ionizer, a thermal ionizer, an ion-impact ionizer.

The devices according to embodiments of the present invention may be made, e.g., using techniques such as described in U.S. patent application Ser. No. 10/917,511, entitled “Patterning Thin Metal Film by Dry Reactive Ion Etching” and/or U.S. application Ser. No. 11/203,407, entitled “Method Of Patterning Ultra-Small Structures,” both of which have been incorporated herein by reference. The nano-resonant structure may comprise any number of resonant microstructures constructed and adapted to produce EMR, e.g., as described above and/or in U.S. application Ser. No. 11/325,448, entitled “Selectable Frequency Light Emitter from Single Metal Layer,” filed Jan. 5, 2006 [Atty. Docket 2549-0060], U.S. application Ser. No. 11/325,432, entitled, “Matrix Array Display,” filed Jan. 5, 2006, and U.S. application Ser. No. 11/243,476 [Atty. Docket 2549-0058], filed on Oct. 5, 2005, entitled “Structures And Methods For Coupling Energy From An Electromagnetic Wave”; U.S. application Ser. No. 11/243,477 [Atty. Docket 2549-0059], filed on Oct. 5, 2005, entitled “Electron beam induced resonance;” and U.S. application Ser. No. 11/302,471, entitled “Coupled Nano-Resonating Energy Emitting Structures,” filed Dec. 14, 2005 [atty. docket 2549-0056].

Those of skill in the art will immediately understand, upon reading this description, that the “N” and “S” states may be used to represent binary values “0” and “1”.

All of the ultra-small resonant structures described are preferably under vacuum conditions during operation. Accordingly, in each of the exemplary embodiments described herein may be vacuum packaged. Alternatively, the portion of the package containing at least the ultra-small resonant structure(s) should be vacuum packaged. Our invention does not require any particular kind of evacuation structure. Many known hermetic sealing techniques can be employed to ensure the vacuum condition remains during a reasonable lifespan of operation. We anticipate that the devices can be operated in a pressure up to atmospheric pressure if the mean free path of the electrons is longer than the device length at the operating pressure.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method comprising:
providing a multi-state magnetic cell;
providing an ultra-small resonant structure;
directing a charged particle beam along a path near the magnetic cell, whereby the particle beam is deflected in a first direction toward the ultra-small resonant structure when the magnetic cell is in a first state, and the particle beam is deflected away from the ultra-small resonant structure when the magnetic cell is in a second state distinct from the first state.

2. A method as in claim 1 further comprising:
providing a second ultra-small resonant structure, whereby the particle beam is deflected in a second direction toward the second ultra-small resonant structure when the magnetic cell is in the second state.

3. A method as in claim 1 wherein the ultra-small resonant structure is a light-emitting resonant structure.

4. A method as in claim 2 wherein the ultra-small resonant structure is a first light-emitting resonant structure and the second ultra-small resonant structure is a second light-emitting resonant structure.

5. A method as in claim 4 wherein the first light-emitting resonant structure emits light at a first wavelength and the second light-emitting resonant structure emit light at a second wavelength distinct from the first wavelength.

6. A method as in claim 4 wherein the first light-emitting resonant structure emits light of a first color and the second light-emitting resonant structure emit light of a second color distinct from the first color.

7. A method comprising:
providing a multi-state magnetic cell;
providing an first ultra-small resonant structure and a second ultra-small resonant structure;
directing a charged particle beam along a path near the magnetic cell, whereby the particle beam is deflected in a first direction toward the first ultra-small resonant structure when the magnetic cell is in a first state, and the particle beam is deflected away from the first ultra-small resonant structure and toward the second ultra-small resonant structure when the magnetic cell is in a second state distinct from the first state.

8. A method as in claim 7 wherein at least one of the first ultra-small resonant structure and the second ultra small resonant structure is a light-emitting resonant structure.

9. A method as in claim 7 wherein the first ultra-small resonant structure emits light at a first wavelength and the second ultra-small resonant structure emits light at a second wavelength distinct from the first wavelength.

10. A method as in claim 7 wherein the first ultra-small resonant structure emits light of a first color and the second ultra-small resonant structure emits light of a second color distinct from the first color.

11. A method as in claim 1 wherein the ultra-small resonant structure comprises a detector.

12. A method as in any one of claims 1-11 wherein the beam of charged particles comprises particles selected from the group comprising:
positive ions, negative ions, electrons, and protons and the like.

13. A device comprising:
an emitter constructed and adapted to emit a charged particle beam;
a multi-state magnetic cell disposed on a path of the particle beam, whereby the particle beam is deflected along a first deflection path when the cell is in a first magnetic state, and the particle beam is deflected along a second deflection path, distinct from the first deflection path, when the cell is in a second magnetic state;
a first ultra-small resonant structure positioned on the first deflection path.

14. A device as in claim 13 further comprising:
a second ultra-small resonant structure positioned on the second deflection path.

15. A device as in claim 13 wherein the first ultra-small resonant structure comprises a light-emitting structure.

16. A device as in claim 14 wherein the first ultra-small resonant structure comprises a first light-emitting structure, and the second ultra-small resonant structure comprises a second light-emitting structure.

17. A device as in claim 16 wherein the first light-emitting resonant structure emits light at a first wavelength and the second light-emitting resonant structure emit light at a second wavelength distinct from the first wavelength.

18. A device as in claim 16 wherein the first light-emitting resonant structure emits light of a first color and the second light-emitting resonant structure emit light of a second color distinct from the first color.

19. A device comprising:
an emitter constructed and adapted to emit a charged particle beam;
a multi-state magnetic cell disposed on a path of the particle beam, whereby the particle beam is deflected along a first deflection path when the cell is in a first magnetic state, and the particle beam is deflected along a second deflection path, distinct from the first deflection path, when the cell is in a second magnetic state;
a first ultra-small resonant structure positioned on the first deflection path;
a second ultra-small resonant structure positioned on the second deflection path, wherein the first ultra-small resonant structure comprises a first light-emitting structure, and the second ultra-small resonant structure comprises a second light-emitting structure, and wherein the first light-emitting resonant structure emits light at a first wavelength and the second light-emitting resonant structure emit light at a second wavelength distinct from the first wavelength.

20. A method of detecting a state of a magnetic device, the device having a first state and a second state, the second state being distinct from the first state, the method comprising:
directing a beam of charged particles near the magnetic device;
detecting deflection in the beam in a first direction, the first direction being indicative of the magnetic device being in the first state.

21. A method as in claim 20 further comprising:
detecting deflection of the beam in a second direction, distinct from the first direction, the second direction being indicative of the magnetic device being in the second state.

22. A method as in any one of claims 21 and 22 wherein the states are used to represent a binary zero value and a binary one value.
